(19) United States
(12) Patent Application Publication
(10) Pub. No.: US 2010/0228525 A1
(43) Pub. Date: Sep. 9, 2010

(54) DATA LOGGER FOR HYBRID VEHICLE

(76) Inventors: Christopher Thomas Arneson, New Market, MN (US); Robert Leslie Isaacs, Buffalo, MN (US); Vincent Joseph Duray, Edina, MN (US)

Correspondence Address: MERCHANT & GOULD PC, P.O. BOX 2903, MINNEAPOLIS, MN, 55402-0903, US

(21) Appl. No.: 12/718,327

(22) Filed: Mar. 5, 2010

Related U.S. Application Data
(60) Provisional application No. 61/158,542, filed on Mar. 9, 2009.

(51) Int. Cl. G06F 17/40; G06F 15/00

(52) U.S. Cl. 702/182; 702/187

(57) ABSTRACT

A data logging system includes a sensor for monitoring a parameter and a data logger. The data logger includes a first logging mode and a second logging mode. The first logging mode has a low-capacity logging mode adapted to collect data from the sensor at time intervals, identify a start of a data cycle when the parameter reaches a first limit, identify a stop of the data cycle when the parameter reaches a second limit, process the data collected between the start and stop of the data cycle, log the data processed, the data processed having less bytes than the data collected between the start and stop of the data cycle. The second logging mode is adapted to collect data from the sensor at time intervals and to log a portion of the data collected after receiving an event code.

### CROSS REFERENCE TO RELATED APPLICATIONS

This application claims the benefit of U.S. Provisional Patent Application Ser. No. 61/158,542, entitled “Data Logger for Hybrid Vehicle” and filed on Mar. 9, 2009, the disclosure of which is hereby incorporated by reference in its entirety.

### BACKGROUND

On-highway and off-highway hybrid vehicles are vehicles that include multiple power sources. In one example, the hybrid vehicle may use a conventional gas powered engine to propel the vehicle in one mode of operation and an electric motor to propel the vehicle in another mode of operation. In another example, the hybrid vehicle may use a conventional gas powered engine to propel the vehicle in one mode of operation and a fluid motor to propel the vehicle in another mode of operation. As a result of the multiple power sources, hybrid vehicles provide cost efficient operation.

### SUMMARY

An aspect of the present disclosure relates to a data logging system that collects time-based data. The data logging system converts the time-based data to cycle-based data and event-based data.

An aspect of the present disclosure relates to a data logging system. The data logging system includes a sensor for monitoring a parameter. A data logger in communication with the sensor. The data logger includes a first data logging mode and a second data logging mode. The first data logging mode has a low-capacity logging mode that is adapted to collect data from the sensor at time intervals, identify a start of a data cycle when the parameter reaches a first limit, identify a stop of the data cycle when the parameter reaches a second limit, process the data collected between the start and stop of the data cycle, log the data processed between the start and stop of the data cycle, the data processed between the start and stop of the data cycle having less bytes than the data collected between the start and stop of the data cycle. The second data logging mode is adapted to collect data from the sensor at time intervals and to log a portion of the data collected after receiving an event code.

Another aspect of the present disclosure relates to a drive system. The drive system includes a power source having a fluid reservoir, a pump/motor unit in fluid communication with the fluid reservoir, and an energy storage unit in fluid communication with the pump motor unit. A plurality of sensors is adapted to monitor the power source. A data logger is adapted to log data from the plurality of sensors. The data logger has a microprocessor and a non-volatile memory component. The data logger includes a first data logging mode and a second data logging mode. The first data logging mode has a low-capacity logging mode that is adapted to collect data from the plurality of sensors at time intervals, identify a start of a data cycle when an output from at least one of the plurality of sensors reaches a first limit, identify a stop of the data cycle when the output reaches a second limit, process the data collected between the start and stop of the data cycle, log the data processed between the start and stop of the data cycle, the data processed between the start and stop of the data cycle having less bytes than the data collected between the start and stop of the data cycle. The second data logging mode is adapted to collect data from the sensor at time intervals and to log a portion of the data collected after receiving an event code.

Another aspect of the present disclosure relates to a method for logging data. The method includes collecting data from a plurality of sensors at time intervals. A start of a data cycle is identified when an output from at least one of the plurality of sensors reaches a first limit. A stop of the data cycle is identified when the output reaches a second limit. The data between the start and stop of the data cycle is processed. The data processed between the start and stop of the data cycle is logged. The data processed between the start and stop of the data cycle has less bytes than the data collected between the start and stop of the data cycle.

Another aspect of the present disclosure relates to a method for logging data. The method includes collecting time-based data from a plurality of sensors. The time-based data is converted to cycle-based data. The cycle based data is logged on a non-volatile memory component. The time-based data is converted to event-based data when an event code is received. The event-based data is logged on the non-volatile memory component.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a schematic representation of a drive system of a hybrid vehicle having exemplary features of aspects in accordance with the principles of the present disclosure.

FIG. 2 is a schematic representation of an alternate embodiment of a drive system of a hybrid vehicle.

FIG. 3 is a schematic representation of a data logger suitable for use with the drive system of FIG. 1.

FIG. 4 is a representation of an exemplary method for logging data on the data logger of FIG. 3.

FIG. 5 is a representation of an alternate method for logging data on the data logger of FIG. 3.

FIGS. 6-8 are graphical representations of the method for logging data on the data logger of FIG. 3 using a first data logging mode.

FIG. 9 is a representation of an exemplary method for logging data on the data logger of FIG. 3 using a second data logging mode.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

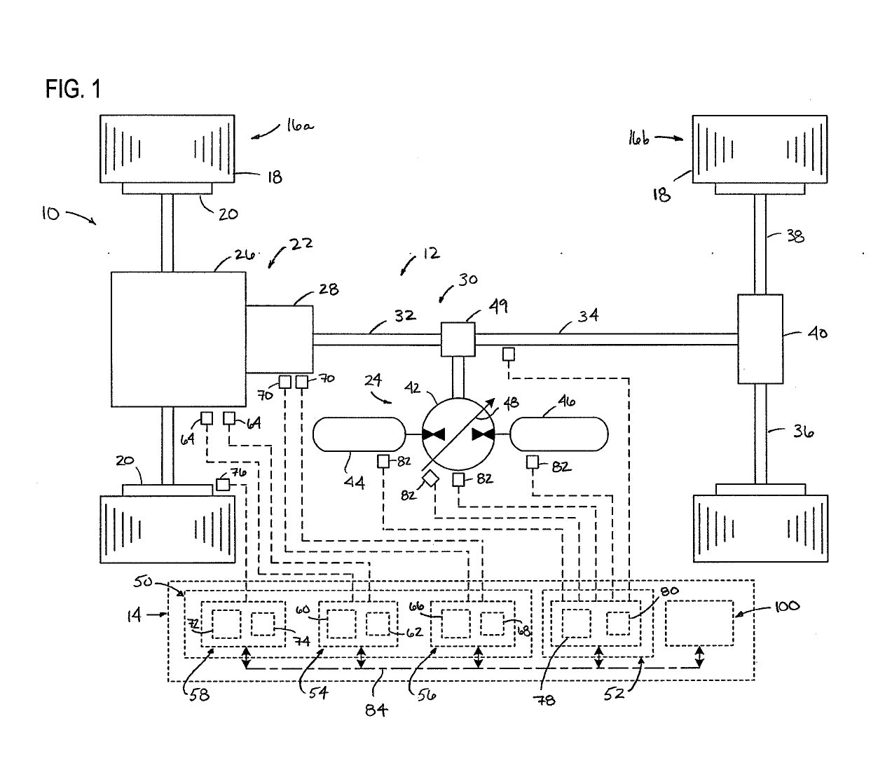

Referring now to FIG. 1, a schematic representation of a drive system, generally designated 10, of a vehicle is shown. In one aspect of the present disclosure, the drive system 10 is suitable for use in an on-highway vehicle, such as a truck, a refuse truck, a bus or an automobile, or an off-highway vehicle, such as construction and agriculture vehicles.

In the depicted example of FIG. 1, the drive system 10 includes a hybrid drive assembly, generally designated 12, and a control system, generally designated 14. The hybrid drive assembly 12 is adapted to selectively propel the vehicle while the control system 14 is adapted to control the hybrid drive assembly 12.

In one aspect of the present disclosure, the drive system 10 further includes a front plurality of wheels 16a and a rear plurality of wheels 16b. Each of the front and rear plurality of wheels 16a, 16b includes at least two wheels 18. A brake 20 is operably associated with each of the wheels 18 of the front and rear plurality of wheels 16a, 16b of the drive system 10. The brakes 20 are adapted to selectively decrease the kinetic energy of the vehicle. In one aspect of the present disclosure, the brakes 20 are friction brakes. Friction brakes that are suitable for use in the drive system 10 include, but are not limited to, disk brakes, drum brakes, mechanically actuated brakes, hydraulically actuated brakes, electronically actuated brakes, or combinations thereof.

The hybrid drive assembly 12 of the drive system 10 includes a first power source, generally designated 22, and a second power source, generally designated 24. In the depicted example of FIG. 1, the second power source 24 is disposed in parallel to the first power source 22.

In one aspect of the present disclosure, the first power source 22 of the hybrid drive assembly 12 includes a conventional prime mover 26, such as an internal combustion engine. In another aspect of the present disclosure, the first power source 22 also includes a conventional transmission 28. The prime mover 26 generates power in response to combustion of fuel. The transmission 28 directs the power from the prime mover 26 to at least one of wheels 18 of the front and/or rear plurality of wheels 16a, 16b through a drive line, generally designated 30.

In one aspect of the present disclosure, the drive line 30 includes a front drive shaft 32, a rear drive shaft 34, left and right axle shafts 36, 38 and a differential 40. The differential 40 is disposed between the left and right axle shafts 36, 38.

In one aspect of the present disclosure, the second power source 24 is a hydraulic power source. The second power source 24 includes a pump/motor unit 42, a fluid reservoir 44 and an energy storage unit 46.

The pump/motor unit 42 is of a variable displacement type. In one aspect of the present disclosure, the pump/motor unit 42 is of the axial piston type. The pump/motor unit 42 includes a servo actuator that is engaged to a variable swashplate 48. The servo actuator is adapted to selectively adjust the angle of the swashplate 48, which adjusts the displacement of the pump/motor unit 42.

The pump/motor unit 42 is in selective fluid communication with a fluid reservoir 44 and an energy storage unit 46. In one aspect of the present disclosure, the energy storage unit 46 is an accumulator. In another aspect of the present disclosure, the energy storage unit 46 is a gas-charged accumulator.

The second power source 24 further includes an engagement assembly 49. In one aspect of the present disclosure, the engagement assembly 49 is disposed between the front and rear drive shafts 32, 34. The engagement assembly 49 is adapted to selectively engage the pump/motor unit 42 to the drive line 30. In one aspect of the present disclosure, the engagement assembly 49 is a clutch. In another aspect of the present disclosure, the engagement assembly 49 is a transfer case.

In one aspect of the present disclosure, the engagement assembly 49 is adapted to engage the pump/motor unit 42 to the drive line 30 when the vehicle decelerates. During deceleration, the pump/motor unit 42 is engaged with the drive line 30 and acts as a pump to pump fluid from the fluid reservoir 44 to the energy storage unit 46. As the fluid is pumped to the energy storage unit 46, the pressure of the fluid in the energy storage unit 46 increases.

In another aspect of the present disclosure, the engagement assembly 49 is adapted to engage the pump/motor unit 42 to the drive line 30 when the vehicle accelerates. During acceleration, the pump/motor unit 42 is engaged with the drive line 30 and acts as a motor. The pump/motor unit 42 receives pressurized fluid from the energy storage unit 46, which results in rotation of an output shaft of the pump/motor unit 42 that transmits torque to the drive line 30. This torque generated from the pump/motor unit 42 and transmitted to the drive line 30 is used to propel the vehicle.

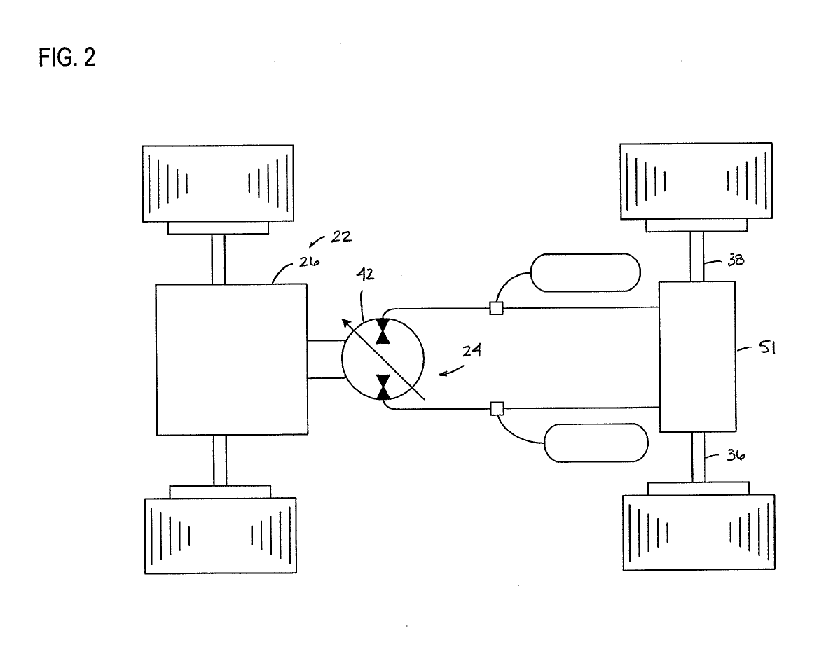

In the depicted example of FIG. 2, the first and second power sources 22, 24 are disposed in series. In the series configuration, the prime mover 26 is coupled to the pump/motor unit 42. The pump/motor unit 42 is in fluid communication with a motor assembly 51 that is coupled to the left and right axle shafts 36, 38.

Referring now to FIG. 1, an exemplary embodiment of the control system 14 will be described. In one aspect of the present disclosure, the control system 14 includes a first power source control system, generally designated 50, and a second power source control system, generally designated 52.

The first power source control system 50 is adapted to control the first power source 22. In one aspect of the present disclosure, the first power source control system 50 includes a prime mover control unit 54, a transmission control unit 56 and a brake control unit 58. While the prime mover control unit 54 and the transmission control unit 56 can be combined into a singe powertrain control module, the prime mover control unit 54 and the transmission control unit 56 will be described herein as being separate units.

The prime mover control unit 54 is adapted to control the operational aspects of the prime mover 26. For example, when used with an internal combustion type engine, the prime mover control unit 54 can be adapted to control any one or more of the amount of fuel injected into the engine, the idle speed of the engine, ignition timing, and/or engine valve timing.

In one aspect of the present disclosure, the prime mover control unit 54 includes a microprocessor 60 and a non-volatile memory component 62. The microprocessor 60 of the prime mover control unit 54 is adapted to receive electronic data signals from a plurality of prime mover sensors 64. In one aspect of the present disclosure, the prime mover sensors 64 can include any one or more of a throttle position sensor, an oxygen sensor, a rpm sensor, a mass airflow sensor, a manifold absolute pressure (MAP) sensor, a coolant sensor, a knock sensor, a crankshaft position sensor, an oil temperature sensor, etc.

The microprocessor 60 of the prime mover control unit 54 is adapted to calculate control parameters for the prime mover 26 from algorithms stored on the non-volatile memory component 62. The control parameters are calculated using the electronic data signals received from the plurality of prime mover sensors 64 and are used to control the operation of the prime mover 26.

The non-volatile memory component 62 stores software, firmware, etc. that is used by the microprocessor 60 to control the prime mover 26 and to make the control parameter calculations. The non-volatile memory component 62 is capable of storing the software, firmware, etc. when the prime mover control unit 54 is not powered. An exemplary non-volatile memory component suitable for use with the prime mover control unit 54 includes, but is not limited to, Erasable Programmable Read-Only Memory (EPROM), Electrically Erasable Programmable Read-Only Memory (EEPROM), flash memory, etc.

The transmission control unit 56 is adapted to control the operational aspects of the transmission 28. For example, the transmission control unit 56 can be used to calculate how and when to change gears in the vehicle in order to optimize fuel efficiency and/or vehicle performance.

In one aspect of the present disclosure, the transmission control unit 56 includes a microprocessor 66 and a non-volatile memory component 68 (e.g., EPROM, EEPROM, flash memory, etc.). The microprocessor 66 of the transmission control unit 56 is adapted to receive electronic data signal inputs from a plurality of transmission sensors 70. In one aspect of the present disclosure, the transmission sensors 70 can include any one or more of an input speed sensor, an output speed sensor, a wheel speed sensor, a throttle position sensor, a transmission fluid temperature sensor, etc. In another aspect of the present disclosure, the transmission control unit 56 can be adapted to receive electronic data signal inputs from any one or more of a kick down switch, which is used to determine if the accelerator has been depressed past full throttle, a traction control system, a cruise control module, etc.

The microprocessor 66 of the transmission control unit 56 is adapted to calculate control parameters for the transmission 28 from algorithms stored on the non-volatile memory component 68. The control parameters are calculated using the electronic data signals received from the plurality of transmission sensors 70 and are used to control the operation of the transmission 28.

The brake control unit 58 is adapted to control the operational aspects of the brakes 20. For example, the brake control unit 58 can be adapted to provide anti-lock braking during various driving conditions and/or to provide a uniform relationship between pedal effort and brake effectiveness.

In one aspect of the present disclosure, the brake control unit 58 includes a microprocessor 72 and a non-volatile memory component 74 (e.g., EPROM, EEPROM, flash memory, etc.). The microprocessor 72 of the brake control unit 58 is adapted to receive electronic data signal inputs from a plurality of brake sensors 76. In one aspect of the present disclosure, the brake sensors 76 can include any one or more of wheel speed sensors, a pressure sensor for monitoring pressure of brake fluid, a pedal position sensor, etc.

The microprocessor 72 of the brake control unit 58 is adapted to calculate control parameters for the brakes 20 from algorithms stored on the non-volatile memory component 74. The control parameters are calculated using the electronic data signals received from the plurality of brake sensors 76 and are used to control the operation of the brakes 20.

The second power source control system 52 is adapted to control the operational aspects of the second power source 24. In one aspect of the present disclosure, the second power source control system 52 is also adapted to selectively control an operational aspect of the prime mover 26 of the first power source 22. For example, the second power source control system 52 can be adapted to limit the torque output of the prime mover 26 when the second power source 24 is actively engaged to the drive line 30.

In one aspect of the present disclosure, the second power source control system 52 includes a microprocessor 78 and a non-volatile memory component 80 (e.g., EPROM, EEPROM, flash memory, etc.). The microprocessor 78 is adapted to receive electronic data signal inputs from a plurality of sensors 82. In one aspect of the present disclosure, the plurality of sensors 82 can include any one or more of an accumulator pressure sensor, a pump/motor speed sensor, a reservoir fluid temperature sensor, a reservoir fluid level sensor, a swashplate angle sensor, etc.

The microprocessor 78 of the second power source control system 52 is adapted to calculate control parameters for the second power source 24 from control algorithms stored on the non-volatile memory component 80 of the second power source control system 52. The control parameters are calculated using the electronic data signals received from the plurality of sensors 82.

In one aspect of the present disclosure, the prime mover control unit 54, the transmission control unit 56, the brake control unit 58 and the second power source control system 52 communicate with the associated sensors and with each other via a communication network 84 (shown in FIG. 1 as a dashed line). In one aspect of the present disclosure, the communication network 84 is a controller-area network (CAN or CAN-Bus). In another aspect of the present disclosure, the communication network 84 utilizes a J1939 protocol.

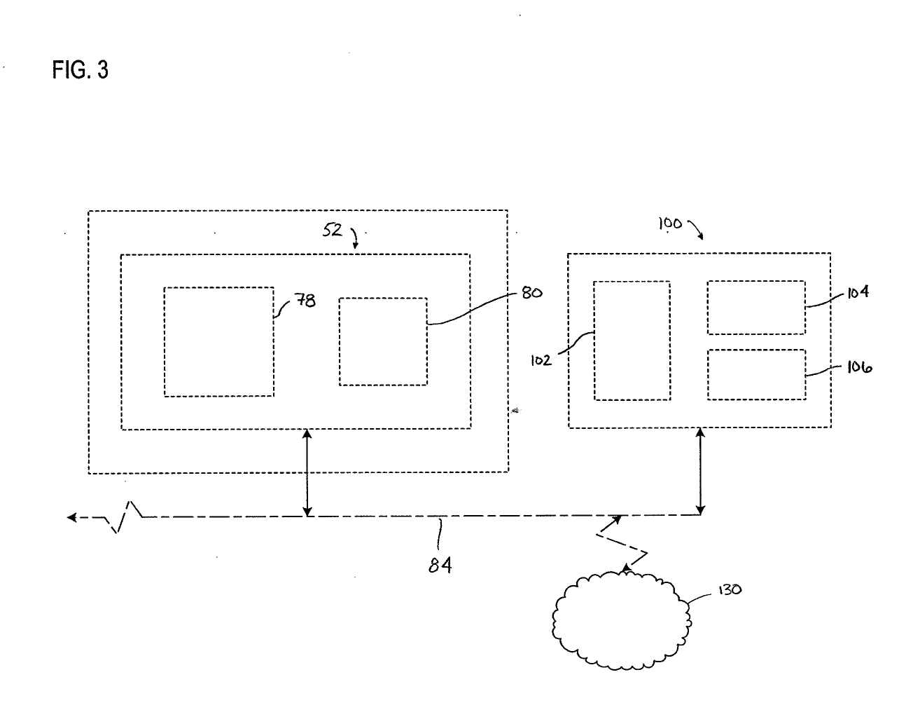

Referring now to FIGS. 1 and 3, the control system 14 further includes a data logger 100. The data logger 100 is adapted to collect and log data related to the drive system 10 of the vehicle. In one aspect of the present disclosure, the data logger 100 is in data communication with the second power source control system 52. In another aspect of the present disclosure, the data logger 100 is in data communication with each of the prime mover control unit 54, the transmission control unit 56, the brake control unit 58 and the second power source control system 52 through the communication network 84.

The data logger 100 collects time-based data related to the drive system 10 of the vehicle. The term “time-based data” refers to data that is collected at predetermined time intervals. In one aspect of the present disclosure, the data logger 100 collects time-based data at predetermined time intervals of less than or equal to about 10 milliseconds. In another aspect of the present disclosure, the data logger 100 collects time-based data at predetermined time intervals of less than or equal to about 5 milliseconds.

In one aspect of the present disclosure, the data logger 100 includes a first data logging mode and a second data logging mode. The first data logging mode is active during operation of the vehicle. The first data logging mode is a cycle-based logging mode, in which the time-based data collected by the data logger 100 is converted to cycle-based data. The term “cycle-based data” refers to data that is based on a cyclical operational aspect of the vehicle (e.g., the start and stop of the vehicle, acceleration/deceleration of the vehicle, etc.). This cycle-based data is recorded, logged or stored on the data logger 100.

The second data logging mode is an event-based logging mode, in which the time-based data collected by the data logger 100 is converted to event-based data. The term “event-based data” refers to data that is based on the occurrence of an event during operation of the vehicle. In one aspect of the present disclosure, the event is a fault in the drive system 10 of the vehicle. The event-based data is then recorded, logged or stored on the data logger 100.

In one aspect of the present disclosure, the second data logging mode is initiated upon receipt of a fault code. The second data logging mode can be active while the first data logging mode is active.

The data logger 100 includes a microprocessor 102, a volatile memory component 104, and a non-volatile memory component 106 (e.g., flash memory, hard disk drive, etc.). In one aspect of the present disclosure, the microprocessor 102 of the data logger 100 is adapted to convert the collected time-based data to cycle-based data and to event-based data.

The volatile memory component 104 is adapted to temporarily store the collected time-based data. The volatile memory component 104 is capable of storing the collected time-based data while the data logger 100 is powered. If power to the data logger 100 is terminated (e.g., when the vehicle is turned off, etc.), the collected time-based data is erased from the volatile memory component 104. An exemplary volatile memory component that is suitable for use with the data logger 100 includes, but is not limited to, random access memory (RAM), dynamic random access memory (DRAM), static random access memory (SRAM), etc.

The non-volatile memory component 106 of the data logger 100 is adapted to store the cycle-based data and/or the event-based data. The non-volatile memory component 106 is capable of storing the cycle-based data and the event-based data while the data logger 100 is powered or when power to the data logger 100 has been terminated. An exemplary non-volatile memory component suitable for use with the data logger 100 includes, but is not limited to, flash memory, a hard disk drive, etc.

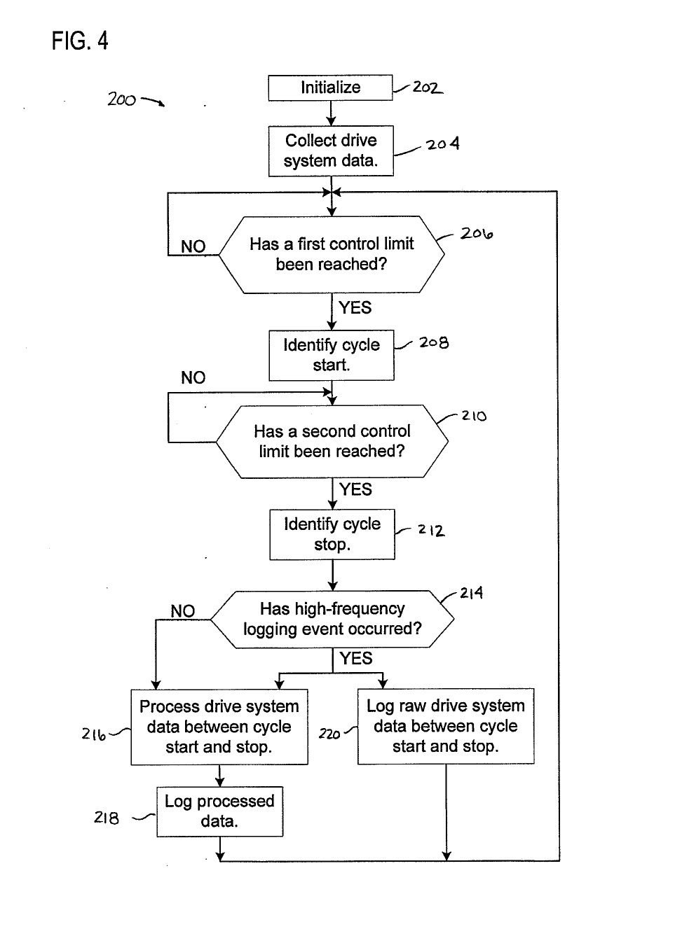

Referring now to FIG. 4, an exemplary method 200 for logging data using the first data logging mode will be described. In step 202, the data logger 100 is initialized. In one aspect of the present disclosure, the data logger 100 is initialized when the vehicle is turned on. During initialization, the data logger 100 turns on and establishes connectivity to the communication network 84.

In step 204, the data logger 100 collects data related to the drive system 10. The collected data can be temporarily stored on the volatile memory component 104. It will be understood that the collected data is raw data (i.e., data that has not been processed by the data logger 100). In one aspect of the present disclosure, the data logger 100 collects raw data from each of the prime mover control unit 54, the transmission control unit 56, the brake control unit 58 and the second power source control system 52 through the communication network 84. As previously provided, the raw data is collected at the predetermined time interval.

The raw data includes data related to a plurality of parameters of the drive system 10. In step 206, the data for at least one of the parameters of the raw data is compared to a first control limit. The first control limit is a predefined value. In one aspect of the present disclosure, the parameter is vehicle speed. In another aspect of the present disclosure, the parameter is accelerator pedal position. In another aspect of the present disclosure, the parameter is rotating speed of the rear drive shaft 34. In another aspect of the present disclosure, the parameter is a difference in fluid pressure (delta pressure) in the energy storage unit 46 between successive data points. In step 208, the data collected at that particular time interval when the parameter reaches the first control limit is designated as the beginning of a data cycle.

In one example, the parameter is vehicle speed and the first control limit is set as 2 miles per hour (mph). The beginning of the data cycle is identified when the vehicle speed reaches or exceeds 2 mph (the first control limit). If the vehicle speed does not reach or exceed the 2 mph control limit, the data logger continues to collect data related to the drive system 10 but does not identify the beginning of the data cycle until the first control limit has been reached.

In step 210, the data for at least one of the parameters is compared to a second control limit. In one aspect of the present disclosure, the second control limit is the same as the first control limit. In another aspect of the present disclosure, the second control limit is different than the first control limit. In step 212, the data collected at that particular time interval when the parameter reaches the second control limit is designated as the end of the data cycle.

In the example provided above in which the parameter is vehicle speed, the second control limit is set at 0 mph. The end of the data cycle is identified when the vehicle speed reaches 0 mph. If the vehicle speed does not reach the 0 mph control limit, the data logger continues to collect data related to the drive system 10 for the cycle.

In step 214, the data logger 100 determines whether or not a high-capacity logging event has occurred. The first data logging mode includes a low-capacity logging mode and a high capacity logging mode. In one aspect of the present disclosure, the data logger 100 always logs data using the low-capacity logging mode. If the high-capacity logging event has occurred, the data logger 100 also logs data using the high-capacity logging mode. In another aspect of the present disclosure, the data logger 100 determines whether to use the low-capacity logging mode or the high-capacity logging mode based on the occurrence of the high-capacity logging event.

In one aspect of the present disclosure, the high-capacity logging event occurs every N number of cycles. For example, the high-capacity logging event may occur every tenth, hundredth, or thousandth cycle.

If the high-capacity logging event has not occurred, the raw data related to the drive system 10 that is collected between the identified beginning and end of the data cycle is processed in step 216. In one aspect of the present disclosure, the raw data is processed such that the processed data includes only average values for the vehicle parameters during the data cycle. In another aspect of the present disclosure, the raw data is processed such that the processed data includes only minimum, maximum and average values for the parameters during the data cycle. In step 218, the processed data of step 216 is reported, stored or logged on the non-volatile memory component 106 of the data logger 100.

In one aspect of the present disclosure, the amount of processed data is less than the amount of raw data. In another aspect of the present disclosure, the processed data between the start and stop of the data cycle has less bytes than the data collected between the start and stop of the data cycle. In another aspect of the present disclosure, the processed data is adapted to occupy less storage space on the non-volatile memory component 106 than the raw data between the start and stop of the data cycle.

If the high-capacity logging event has occurred, the data logger 100 logs the raw data collected between the start and stop of the data cycle in step 220. In one aspect of the present disclosure, the data logger 100 also processes the raw data and logs the processed data in parallel. In this aspect of the present disclosure, the data logger 100 provides two sets of data for a given data cycle if the high-capacity logging event has occurred. The first set of data is the data that has been processed. The second set of data is the raw data collected between the cycle start and the cycle stop.

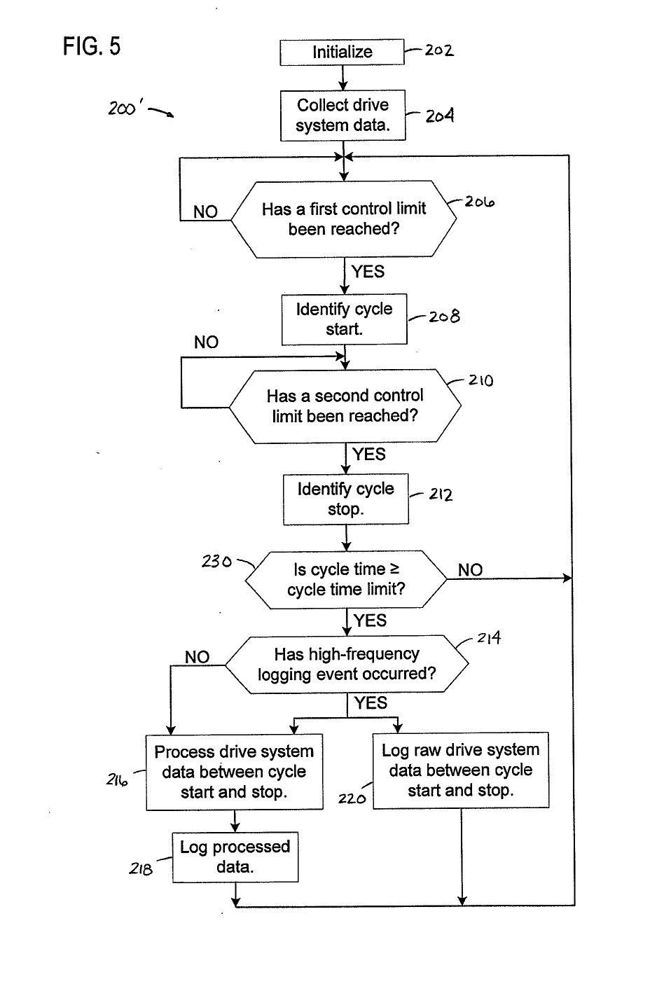

Referring now to FIG. 5, an alternate method 200′ for logging data using the first data logging mode is shown. This alternate method 200′ includes steps 202-220, which are described above. The alternate method 200′ also includes a step 230 in which a time of the cycle, as measure between the start and stop of the data cycle, is compared to a predetermined cycle time limit. If the time of the cycle is greater than or equal to the predetermined cycle time limit, the method proceeds to steps 214-220. If, however, the time of the cycle is less than the predetermined cycle time limit, the data related to that cycle is not processed and/or recorded.

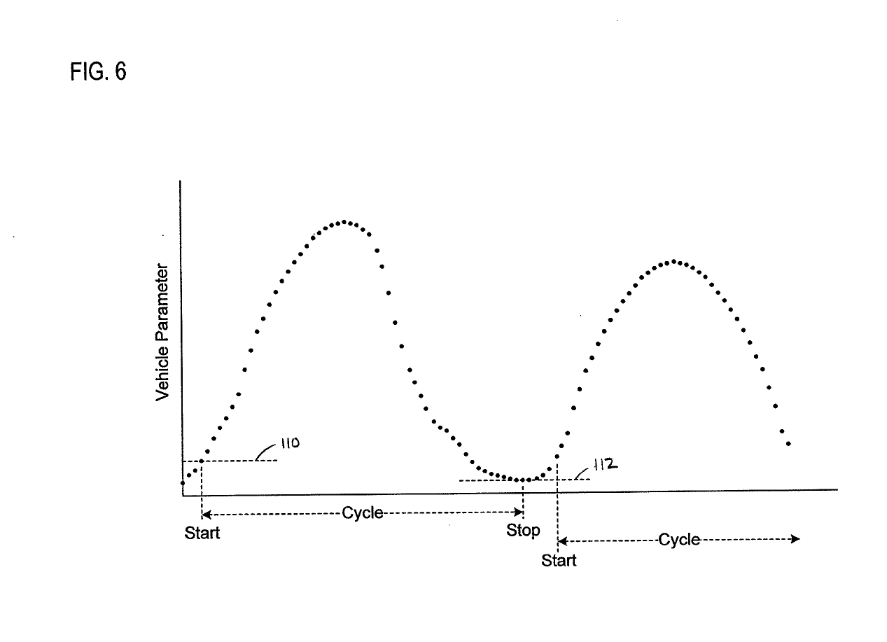

Referring now to FIGS. 6-8, a graphical representation of the method 200 for logging data using the first data logging mode is shown for one parameter. While FIGS. 6-8 show only one parameter being logged, it will be understood that the scope of the present disclosure is not limited to only one parameter being logged.

FIG. 6 shows raw data collected by the data logger 100 for one parameter. The collected raw data includes data points taken at a predetermined time interval. The data logger 100 identifies the start of the data cycle and the end of the data cycle when the parameter reaches the first control limit 110 (shown as a dashed line in FIG. 5) and the second control limit 112 (shown as a dashed line in FIG. 5), respectively.

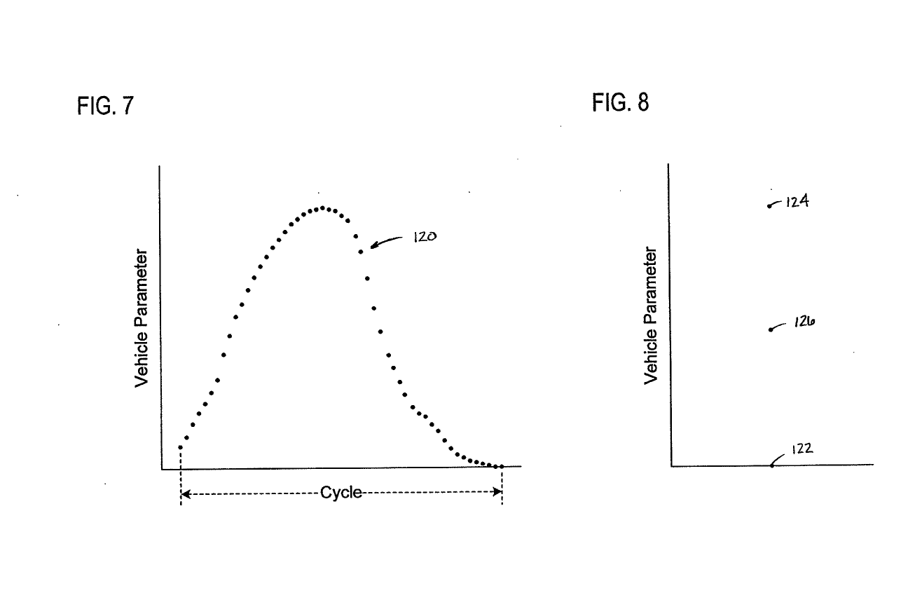

In FIG. 7, the data logger 100 selects data 120 collected between the start and stop of the data cycle. The selected data is then processed by the data logger 100. In FIG. 8, the processed data is shown. In the depicted example of FIG. 8, the processed data includes a minimum value 122 for the parameter during the cycle, a maximum value 124 and an average value 126. The processed data is then logged. In one aspect of the present disclosure, the processed data is logged to the non-volatile memory component 106 of the data logger 100. In another aspect of the present disclosure, the processed data is logged to a memory component at a remote location 130 (shown in FIG. 3) from the data logger 100.

If a high-capacity logging event has occurred, the data logger 100 logs the selected data of between the identified start and stop of the data cycle. In one aspect of the present disclosure, both the selected data of the data cycle and the processed data of the data cycle are logged.

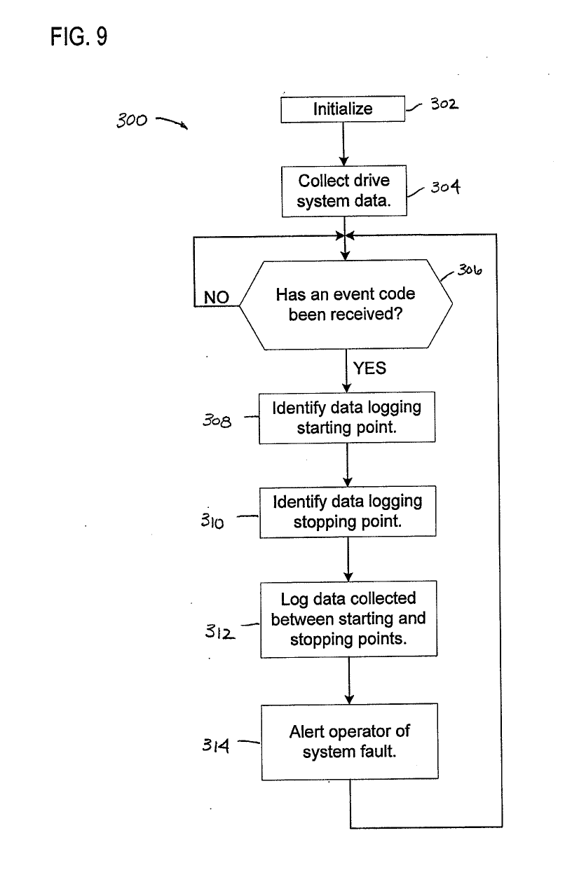

Referring now to FIGS. 1 and 9, an exemplary method 300 for logging data using the second data logging mode will be described. In step 302, the data logger 100 is initialized. During initialization, the data logger 100 turns on and establishes connectivity to the communication network 84. In step 304, the data logger 100 collects raw data related to the drive system 10. As previously provided with regard to the first data logging mode, the raw data is collected at the predetermined time interval.

In step 306, the data logger 100 awaits detection of an event code while still collecting the raw data. In one aspect of the present disclosure, the event code is a fault code. In one aspect of the present disclosure, the fault code is received when one of the parameters is outside an acceptable range of values. In another aspect of the present disclosure, the fault code is received when one of the parameters is below or above a limit. For example, the fault code can be received when one of the plurality of sensors 82 of the second power source control system 52 is outside of a range of values. In another example, the fault code can be received when the supply voltage of one of the plurality of sensors is outside the range of values. In another example, the fault code can be received when the fluid temperature or pressure of the second power source 24 exceeds a limit. In another example, the fault code can be received when the fluid level in the fluid reservoir 44 is below a limit.

In another aspect of the present disclosure, the event code is a signal received from the remote location 130 (shown in FIG. 3). The event code can be transmitted to the data logger 100 through the communication network 84. Alternatively, the event code can be transmitted to the data logger 100 wirelessly from the remote location 130. In one aspect of the present disclosure, the event code is sent to the data logger 100 by the remote location 130 in order to evaluate the proper operation of the drive system 10. In another aspect of the present disclosure, the event code is sent by the remote location 130 in response to a fault.

When the event code is received, the microprocessor 102 of the data logger 100 identifies a starting point from which to log data in step 308. In one aspect of the present disclosure, the starting point is the time at which the event code is received. In another aspect of the present disclosure, the starting point is a time preceding the receipt of the event code. In one example, the starting point is at least 1 minute before the receipt of the event code. In another example, the starting point is at least 5 minutes before the receipt of the event code.

In step 310, a stopping point at which the logging of data is to be stopped is identified. In one aspect of the present disclosure, the stopping point is a time following the receipt of the event code. In another aspect of the present disclosure, the starting point precedes the receipt of the event code by a time that is greater than a time at which the stopping point follows the receipt of the event code. In one example, the stopping point is at least 1 minute after the receipt of the event code. In another example, the stopping point is at least 2 minutes after the receipt of the event code.

In step 312, the data collected between starting and stopping points is logged. In one aspect of the present disclosure, the data collected between the starting and stopping points is logged on the non-volatile memory component 106 of the data logger 100. In another aspect of the present disclosure, the data collected between the starting and stopping points is logged on a memory component at the remote location 130.

In step 314, the data logger 100 sends a signal that is used to alert an operator of a system fault. In one aspect of the present disclosure, an indicator light is illuminated in response to the signal from the data logger 100. In another aspect of the present disclosure, an audible signal is generated in response to the signal from the data logger 100.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A data logging system comprising:
a sensor monitoring a parameter;
a data logger in communication with the sensor, the data logger having a cycle-based data logging mode and an event-based data logging mode;
the cycle-based data logging mode is adapted to:
collect data from the sensor at time intervals;
identify a start of a data cycle when the parameter reaches a first limit;
identify a stop of the data cycle when the parameter reaches a second limit;
process the data collected between the start and stop of the data cycle;
log the data processed between the start and stop of the data cycle, wherein the data processed between the start and stop of the data cycle has less bytes than the data collected between the start and stop of the data cycle;
the event-based data logging mode is adapted to:
collect data from the sensor at time intervals; and
log a portion of the data collected after receiving an event code.

2. The data logging system of claim 1, wherein the data logger includes a microprocessor and a non-volatile memory component in communication with the microprocessor.

3. The data logging system of claim 1, wherein the cycle-based data logging mode includes a high-capacity logging mode, the high-capacity logging mode being adapted to log the data collected between the start and stop of the data cycle.

4. The data logging system of claim 3, wherein the high-capacity logging mode is utilized when a high-capacity logging event occurs.

5. The data logging system of claim 4, wherein the high-capacity logging event occurs at a predetermined number of cycles.

6. The data logging system of claim 5, wherein the high-capacity logging event occurs every predetermined number of cycles.

7. The data logging system of claim 4, wherein the high-capacity logging event is initiated from a remote location.

8. The data logging system of claim 1, wherein the data logger is adapted to transmit the data collected to a remote location.

9. The data logging system of claim 1, wherein the data is logged at a location remote from the data logger.

10. The data logging system of claim 1, wherein the data is processed at a location remote from the data logger.

11. The data logging system of claim 1, wherein the event code is a fault code.

12. A drive system comprising:
a power source having:
a fluid reservoir;
a pump/motor unit in fluid communication with the fluid reservoir;
an energy storage unit in fluid communication with the pump/motor unit;
a plurality of sensors adapted to monitor the power source;
a data logger adapted to log data from the plurality of sensors, the data logger having a microprocessor and a non-volatile memory component, the data logger having a first data logging mode and a second data logging mode;
the first data logging mode is adapted to:
collect data from the plurality of sensors at time intervals;
identify a start of a data cycle when an output from at least one of the plurality of sensors reaches a first limit;
identify a stop of the data cycle when the output reaches a second limit;
process the data between the start and stop of the data cycle;
log the data processed between the start and stop of the data cycle, wherein the data processed between the start and stop of the data cycle has less bytes than the data collected between the start and stop of the data cycle;
the second data logging mode is adapted to:
collect data from the plurality of sensors at time intervals; and
log a portion of the collected data after receiving an event code.

13. The drive system of claim 12, further comprising a prime mover.

14. The drive system of claim 13, further comprising a transmission engaged with the prime mover.

15. The drive system of claim 14, wherein the power source is disposed in parallel with the prime mover.

16. The drive system of claim 12, wherein the first data logging mode includes a high-capacity logging mode, the high-capacity data logging mode is adapted to log the data collected between the start and stop of the data cycle.

17. The drive system of claim 16, wherein the high-capacity logging mode is utilized when a high-capacity logging event occurs.

18. The data logging system of claim 17, wherein the high-capacity logging event is initiated from a remote location.

19. A method for logging data, the method comprising:
collecting data from a plurality of sensors at time intervals;
identifying a start of a data cycle when an output from at least one of the plurality of sensors reaches a first limit;
identifying a stop of the data cycle when the output reaches a second limit;
processing the data between the start and stop of the data cycle; and
logging the data processed between the start and stop of the data cycle, wherein the data processed between the start and stop of the data cycle has less bytes than the data collected between the start and stop of the data cycle.

20. The method of claim 19, wherein the data processed between start and stop of the data cycle includes minimum, maximum and average values for each of the plurality of sensors.

21. A method for logging data, the method comprising:
collecting time-based data from a plurality of sensors;
converting the time-based data to cycle-based data;
logging the cycle based data on a non-volatile memory component;
converting the time-based data to event-based data when an event code is received; and
logging the event-based data on a non-volatile memory component.
